(19) United States
(12) Patent Application Publication
(10) Pub. No.: US 2025/0146202 A1
(43) Pub. Date: May 8, 2025

(54) ELECTRONIC APPARATUS AND CONTROL METHOD THEREOF

(71) Applicant: SAMSUNG ELECTRONICS CO., LTD., Suwon-si (KR)

(72) Inventors: Jooyoo KIM, Suwon-si (KR); Yoobin BAE, Suwon-si (KR); Hyungseon SONG, Suwon-si (KR)

(73) Assignee: SAMSUNG ELECTRONICS CO., LTD., Suwon-si (KR)

(21) Appl. No.: 19/016,951

(22) Filed: Jan. 10, 2025

Related U.S. Application Data
(63) Continuation of application No. PCT/KR2023/010355, filed on Jul. 19, 2023.

(30) Foreign Application Priority Data
Sep. 8, 2022 (KR) 10-2022-0114290

(51) Int. Cl. D06F 34/18; D06F 34/05

(52) U.S. Cl. CPC D06F 34/18; D06F 34/05

(57) ABSTRACT

An electronic apparatus includes a communication device; a memory storing at least one instruction and storing a learning model determining a dry status; and at least one processor configured to execute the at least one instruction. The one or more instructions, when executed by the at least one processor, cause the electronic apparatus to: based on receiving through the communication device actual use dry information including data about a degree of dryness, obtain an indicator of a degree of dryness based on the data about the degree of dryness included in the actual use dry information; obtain a label of the data about the degree of dryness based on the indicator of the degree of dryness; and train the learning model by using the label of the data about the degree of dryness and the actual use dry information.

### CROSS-REFERENCE TO RELATED APPLICATIONS

This application is a by-pass continuation application of International Application No. PCT/KR2023/010355, filed on Jul. 19, 2023, which claims priority to Korean Patent Application No. 10-2022-0114290, filed on Sep. 8, 2022, in the Korean Intellectual Property Office, and the disclosures of which are incorporated by reference herein in their entireties.

### BACKGROUND

### 1. Field

The present disclosure relates to an electronic apparatus and a control method thereof and more particularly, to an electronic apparatus capable of automatically giving a label to actual use data collected without a label and training a learning model by using the given label and the actual use data and a control method thereof.

### 2. Description of Related Art

Recently, as a drying device has been supplied, the drying device providing various functions has been developed. For example, the drying device provides various courses such as standard drying, quick drying, drying particularly for shirts or other articles of clothing, time drying, AI-customized drying, delicate clothing, wool, blankets, towels, blow drying, etc.

The drying device enters into a closing stage if a specific drying condition is satisfied and in the closing stage, a drying cycle is closed after further performing drying for a certain time.

### SUMMARY

According to an aspect of the disclosure, an electronic apparatus includes: a communication device; a memory storing at least one instruction and storing a learning model determining a dry status; and at least one processor configured to execute the at least one instruction. The one or more instructions, when executed by the at least one processor, cause the electronic apparatus to: based on receiving through the communication device actual use dry information including data about a degree of dryness, obtain an indicator of a degree of dryness based on the data about the degree of dryness included in the actual use dry information; obtain a label of the data about the degree of dryness based on the indicator of the degree of dryness; and train the learning model by using the label of the data about the degree of dryness and the actual use dry information.

The one or more instructions, when executed by the at least one processor, may cause the electronic apparatus to obtain the indicator of the degree of dryness based on one or more sensor values within a preset section in the data about the degree of dryness or a value of a sum of the one or more sensor values within the preset section in the data about the degree of dryness.

The one or more instructions, when executed by the at least one processor, may cause the electronic apparatus to obtain the indicator of the degree of dryness is based on a weight value corresponding to material information included in the actual use dry information and the data about the degree of dryness.

The one or more instructions, when executed by the at least one processor, may cause the electronic apparatus to divide a value section of the indicator of the degree of dryness into a plurality of sections and obtain the label about the data about the degree of dryness based on an indicator value separating each section and the indicator of the degree of dryness.

The one or more instructions, when executed by the at least one processor, may cause the electronic apparatus to divide a plurality of indicator values of the degree of dryness into a second plurality of sections by using a quartile method or a clustering method, the plurality of indicator values of the degree of dryness being obtained based on a plurality of actual use dry information.

The one or more instructions, when executed by the at least one processor, may cause the electronic apparatus to train the learning model based on a dry weight, a dry material, the data about the degree of dryness, and the label.

The one or more instructions, when executed by the at least one processor, may cause the electronic apparatus to train the learning model to predict the dry material based on the actual use dry information.

The memory may be configured to store the learning model predicting the dry material. The one or more instructions, when executed by the at least one processor, may cause the electronic apparatus to train the learning model to predict the dry material by inputting the actual use dry information into the learning model and determining the dry status based on the predicted dry material and the actual use dry information.

The one or more instructions, when executed by the at least one processor, may cause the electronic apparatus to control the communication device to transmit the trained learning model to a dry device.

The one or more instructions, when executed by the at least one processor, may cause the electronic apparatus to control the communication device to generate rule information related to closing of a dry cycle based on the trained learning model; and transmit the rule information to a dry device.

According to another aspect of the present disclosure, a control method of an electronic apparatus includes: receiving actual use dry information comprising data about a degree of dryness; obtaining an indicator of the degree of dryness based on the data about the degree of dryness included in the actual use dry information; obtaining a label about the actual use dry information based on the indicator of the degree of dryness; and training a learning model for determining a dry status by using the label and the actual use dry information.

The obtaining the indicator of the degree of dryness may include obtaining the indicator of the degree of dryness based on one or more sensor values within a preset section in the data about the degree of dryness or a value of a sum of the one or more sensor values within the preset section in the data about the degree of dryness.

The obtaining the indicator of the degree of dryness may include obtaining the indicator of the degree of dryness based on a weight value corresponding to material information included in the actual use dry information and the data about the degree of dryness.

The obtaining the label may include dividing a value section of the indicator of the degree of dryness into a plurality of sections and obtaining the label about the data about the degree of dryness based on an indicator value separating each section and the indicator of the degree of dryness.

According to another aspect of the present disclosure, a non-transitory computer readable recording medium storing computer program instructions that are executed by a processor of an electronic apparatus to perform a control method of the electronic apparatus, wherein the control method includes: receiving actual use dry information including data about a degree of dryness; obtaining an indicator of the degree of dryness based on the data about the degree of dryness included in the actual use dry information; obtaining a label about the actual use dry information based on the indicator of the degree of dryness; and training a learning model for determining a dry status by using the label and the actual use dry information.

### BRIEF DESCRIPTION OF THE DRAWINGS

The following drawings attached to this specification illustrate embodiments of the present disclosure and help understand the technical idea of the present disclosure along with the description of the invention below. The present disclosure shall not be construed as limited to the matters stated in the drawings. In the drawings:

FIG. 1 is a view illustrating an electronic system according to one or more embodiments;

FIG. 2 is a sequence diagram illustrating an operation of an electronic system according to one or more embodiments;

FIG. 3 is a block diagram illustrating a configuration of an electronic apparatus according to one or more embodiments;

FIG. 4 is a block diagram illustrating a configuration of a dry device according to one or more embodiments;

FIG. 5 is a view illustrating an example of data about a degree of dryness according to one or more embodiments;

FIG. 6 is a view illustrating a labeling method with respect to a dry result according to one or more embodiments;

FIG. 7 is a view illustrating a learning model according to one or more embodiments;

FIG. 8 is a view illustrating a learning model according to one or more embodiments;

FIG. 9 is a view illustrating a learning model according to one or more embodiments;

FIG. 10 is a view illustrating a control operation of an electronic apparatus according to one or more embodiments;

FIG. 11 is a view illustrating a learning operation of a learning model according to one or more embodiments; and

FIG. 12 is a view illustrating a control operation of a dry device according to one or more embodiments.

### DETAILED DESCRIPTION

The present disclosure is described with reference to the drawings hereinafter.

The terms used in embodiments of the disclosure are selected as general terms which are currently widely used as much as possible in consideration of functions in the disclosure. However, it may be varied depending on intention of those skilled in the art, a precedent, appearance of new technologies, or the like. Also, there is a term which is arbitrarily selected by the applicant in a certain case and in this case, its meaning will be specifically described in the relevant description part of the disclosure. Therefore, the term used in the disclosure should be defined based on the meaning of the term and the entire content throughout the disclosure rather than the simple name of the term.

In the specification, the expressions such as “have”, “may have”, “include”, and “may include” denote the existence of such characteristics (e.g. a numerical value, a function, an operation, and a component such as a part) and do not exclude the existence of additional characteristics.

The expression “at least one of A and/or B” should be interpreted to mean any one of “A” or “B” or “A and B.”

The expressions “1st”, “2nd”, “first”, “second”, or the like used in the specification may be used to describe various elements regardless of any order and/or degree of importance. Also, such expressions are used only to distinguish one element from another element and are not intended to limit the relevant elements.

Singular expressions include plural expressions, unless defined obviously differently in the context. In the application, the term such as “include” or “consist of” should be construed as designating that there are such characteristics, numbers, steps, operations, components, parts, or a combination thereof described in the specification but not as excluding in advance the existence or possibility of adding one or more other characteristics, numbers, steps, operations, components, parts, or a combination thereof.

In the specification, the term “user” may be referred to as a person who uses a dry device or a device which uses the dry device (e.g. an artificial intelligence (AI) device).

Hereinafter, one or more embodiments of the disclosure is more specifically described with reference to the appended drawings.

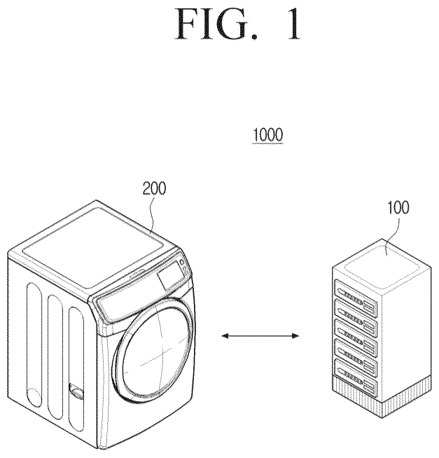

FIG. 1 is a view illustrating an electronic system according to one or more embodiments.

With reference to FIG. 1, an electronic system 1000 includes an electronic apparatus 100 and a dry device 200.

The dry device 200 may be a device for removing moisture of a dry matter. This dry device 200 may be a laundry dry device drying laundry but may be targeted at various objects besides laundry. Further, the dry device 200 as above may be a drier performing only a dry function and may be a washing machine which may also perform other washing functions.

The dry device 200 may include a sensor for identifying a dry status of a dry matter. Here, the sensor may be a touch pulse. The touch pulse is a sensor sensing how many times electrical conduction between two electrodes spaced apart from each other is made within a preset time unit. For example, if a dry matter having moisture contacts two electrodes, currents are conducted between two electrodes and a frequency is counted, thereby outputting how many times this conduction is made within 1 minute as a sensor value.

Further, the dry device 200 may determine whether to close the dry cycle based on a value sensed in the sensor. Specifically, the dry device 200 may determine whether to close the dry cycle based on a dry closing rule or a value satisfying the dry closing rule. Otherwise, the dry device 200 may input the sensed value into the pre-stored learning model, determine whether the dry status of the dry matter is in a normal dry status, and then determine whether to close the dry cycle. Rule information may be a determination criterion as above or the learning model may be offered from the electronic apparatus 100.

Further, the dry device 200 may store a sensor value measured in a sensor in a process of the above dry cycle in a time series and may generate actual use dry information including the stored time series information and information about the above dry cycle (e.g. material information, a weight of the dry matter, etc.).

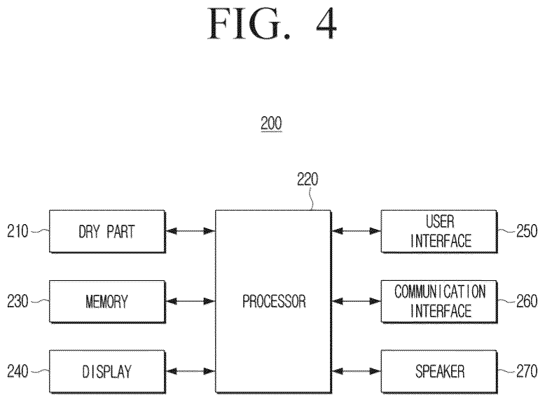

Still further, the dry device 200 may provide the generated actual use dry information to the electronic apparatus 100. The actual use dry information as above may be transmitted whenever one dry cycle is closed, or may be transmitted if the certain number of actual use dry information is collected, or at a regular time point. A specific configuration and an operation of the dry device 200 are described later with reference to FIG. 4.

The electronic apparatus 100 may collect actual use dry information from the dry device 200.

Further, the electronic apparatus 100 may train the learning model based on the collected actual use dry information. Specifically, the electronic apparatus 100 may give a label about the collected actual use dry information and may train the learning model determining the dry status by using the given label and the collected actual use dry information.

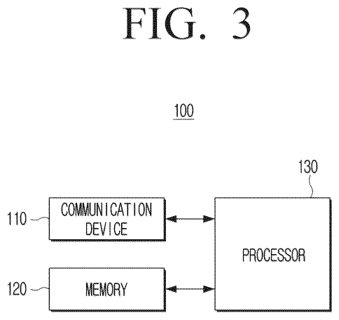

Further, the electronic apparatus 100 may provide the trained learning model to the dry device 200 or may generate and provide rule information required for determining whether to close the dry cycle based on the trained learning model to the dry device 200. A specific configuration and an operation of the electronic apparatus 100 are described later with reference to FIG. 3.

As above, the electronic system 1000 according to the one or more embodiments may be capable of collecting actual use dry information from each dry device and train the learning model by using the collected dry information. As above, the collected various actual use dry information is used. In this regard, the learning model trained in the one or more embodiments may have high accuracy because it is trained based on various actual use information. Also, in the one or more embodiments, labeling is automatically performed by using data about a degree of dryness included in the collected dry information, wherein not only data measured in an experimental environment but also information collected in an actual use environment may be utilized as learning data.

In the shown one or more embodiments, it is illustrated and described that only one server and one dry device are included in the electronic system but a plurality of dry devices may be included in the electronic system 1000. Also, in the shown one or more embodiments, it is illustrated that the dry device 200 and the electronic apparatus 100 are directly connected but upon implementing, information may be received and transmitted between two devices via another electronic apparatus (e.g. a home server, a router, etc.).

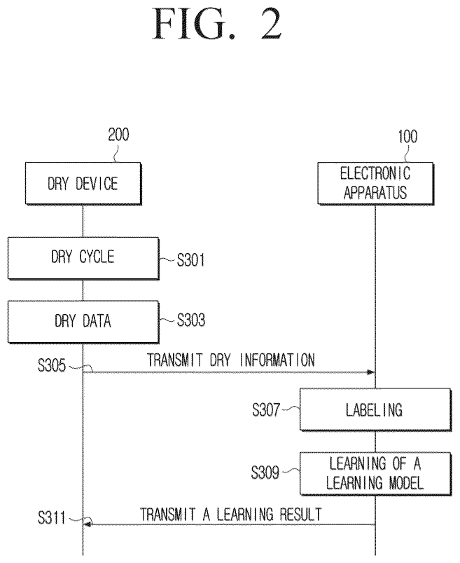

FIG. 2 is a sequence diagram illustrating an operation of an electronic system according to one or more embodiments.

With reference to FIG. 2, the dry device 200 may perform a dry cycle with respect to a dry matter in advance (S301). In this process, the dry device 200 may store data received from the sensor in a time series.

Further, it may generate actual use dry information including information about the time series-received sensor value and information about the dry cycle (S303) and may transmit the generated actual use dry information to the electronic apparatus 100 (S305). Here, the dry device 200 may transmit information capable of identifying the dry device 200 (e.g. a name of a model, a serial number, etc.) and address information (an IP address, etc.) together to the electronic apparatus 100. Further, the actual use dry information may include information about whether to additionally dry.

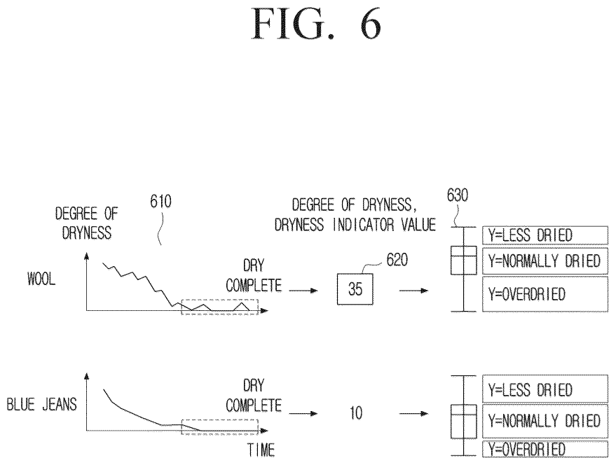

The electronic apparatus 100 may collect dry data from the dry device 200 and may perform labeling with respect to the collected dry data (S307). A specific labeling operation is described later with respect to FIG. 6.

Further, the electronic apparatus 100 may train the learning model by using dry data and a labeling value with respect to the dry data (S309).

Still further, the electronic apparatus 100 may transmit the trained learning model to the dry device 200 (S311). Here, the electronic apparatus 100 may transmit the learning model as it is and may generate rule information based on the learning model and then transmit the generated rule information to the electronic apparatus 100.

Here, the rule information may be used in various methods such as a rule that the dry cycle enters into a closing stage when the indicator of the degree of dryness is a certain value, and a rule that the dry cycle enters into the closing stage when a ratio of a sensor value during a preset period is less than or equal to a preset value, wherein the rule information may be also a combination of various rules.

FIG. 3 is a block diagram illustrating a configuration of an electronic apparatus according to one or more embodiments.

According to FIG. 3, the electronic apparatus 100 may include a communication device 110, memory 120, and at least one processor 130. This electronic apparatus 100 may be various devices such as a personal computer (PC), a notebook, a smart phone, a tablet, and a server.

The communication device 110 is formed to connect the electronic apparatus 100 to an external device, wherein not only a form of connecting to the external device through a local area network (LAN) and an Internet network but also a form of connecting thereto through a universal serial bus (USB) port or a wireless communication (e.g. WiFi 802.11a/b/g/n, NFC, Bluetooth) port are possible. This communication device 310 may be referred to as a transceiver.

The communication device 110 may receive actual use dry information from the dry device 200. Further, the communication device 110 may transmit the trained learning model or rule information generated in the after-mentioned process to the dry device 200.

The memory 120 is a component for storing an O/S for driving the electronic apparatus 100, various software, data, or the like. The memory 320 may be implemented in various forms such as RAM or ROM, flash memory, a HDD, external memory, and a memory card.

The memory 320 stores at least one instruction. These instructions may include a program for training a learning model to be described later, a program labeling data to be used for the learning model, an application for distributing the trained learning model, or the like.

The memory 120 may store the learning model. For example, the learning model used in the one or more embodiments may be a model determining a dry status. This model may be one and may be a model individually operating depending on various conditions. For example, the model may be a model applied to a wool material, a model applied to materials such as blue jeans, and the like and may be a separate model separately divided according to a product of the dry device.

For convenience of explanation, it is described that the learning model is described as a model determining a dry status (for example, less dried, normally dried, over-dried) but the relevant learning model may be a model for directly determining operations of the dry cycle such as requiring additional drying, entering into a closing cycle, and directly closing without entering into the closing cycle based on input data.

Also, the memory 120 may store not only a learning model for classifying the aforementioned dry status but also a learning model for classifying a dry material. The learning model as above may be a model dividing a type of a dry matter (or a type of the dry cycle) based on dry information. This learning model may be referred to as a deep learning model, an AI model, etc.

The processor 130 controls each configuration within the electronic apparatus 100. This processor 330 may be configured as a single device such as a central processing unit (CPU), or an application-specific integrated circuit (ASIC) and may be configured as a plurality of devices such as the CPU or a Graphics Processing Unit (GPU).

If the processor 130 receives actual use dry information through the communication device 110, it may store the received actual use dry information in the memory 120. Further, the processor 130 may filter the received actual use dry information or perform clustering. For example, the processor may classify the actual use dry information according to a type of a product of the dry device or classify the actual use dry information according to a dry cycle (or a dry material). That is, it may classify data with which one learning model is trained among a plurality of data. As above, classification of the actual use dry information may be performed directly before a learning process of the learning model and may be performed at a time point receiving the actual use dry information.

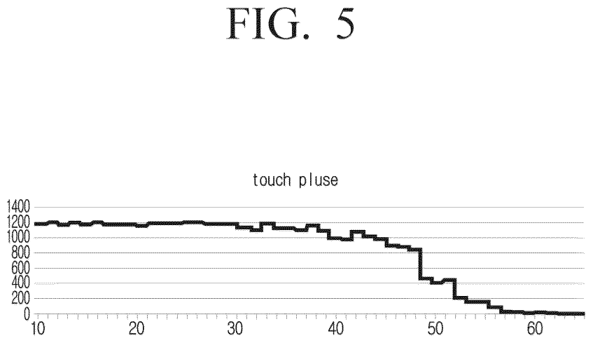

The processor 130 may obtain a label about the actual use dry information. Specifically, the processor 130 may calculate an indicator of a degree of dryness by using data about the degree of dryness included in the actual use dry information and may obtain a label about the data of the degree of dryness by using the calculated indicator of the degree of dryness. An operation of obtaining a label is described with respect to FIGS. 5 and 6.

Here, the processor 130 may obtain a label by using information about performing an additional dry cycle included in the actual use dry information. For example, if the additional dry cycle is performed with respect to the same dry object after the dry cycle, it may be assumed that a dry result of the previous cycle is in a less dried status. Therefore, the processor 130 may determine the actual use dry information including history information where the additional dry cycle is performed as a less dried status.

If the processor 130 obtains a label, it may train the learning model by using the actual use dry information and the obtained label. Here, training means that a predefined operation rule or an AI model is constructed to perform a desired characteristic (or an objective) by training a basic learning model by using a plurality of learning data according to a learning algorithm. This learning may be performed in a device itself where the AI according to the one or more embodiments is performed and also may be performed through a separate server and/or a system. Examples of the learning algorithm are supervised learning, unsupervised learning, semi-supervised learning, or reinforcement learning but the one or more embodiments is limited thereto.

The learning model may be composed of a plurality of neural network layers. Each of the plurality of neural network layers has a plurality of weight values and performs a neural network operation through an operation result of the previous layer and an operation among the plurality of weight values. The plurality of weight values of the plurality of neural network layers may be optimized by the learning result of the learning model. For example, the plurality of weight values may be renewed to reduce or minimize a loss value or a cost value obtained in the learning model during the learning process.

The learning model may include a deep neural network (DNN) and may be for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, or the like but it is not limited thereto.

If the learning model is trained, the processor 130 may distribute the trained learning model. Specifically, the processor 130 may transmit the learning model itself to each dry device 200 or may control the communication device 110 to generate rule information or the like used for determining a closing time point of the dry cycle by using the trained learning model and transmit the generated rule information to each dry device 200.

The rule information as above may be: information that drying is closed when an indicator of the degree of dryness calculated from the basic dry cycle is a certain value or more, information that drying is closed when a sum of the touch pulse values is a certain value or less for a preset time, information that drying is closed when the touch pulses have a certain value or more during a preset time, etc. Further, this rule information may be configured of not only one condition but also a plurality of conditions, wherein it may be rule information applied to one cycle (e.g. a standard course), a plurality of rule information applied to each of a plurality of cycles (e.g. a standard course, a wool course, etc.), or rule information commonly applied to the plurality of cycles.

As above, the electronic apparatus 100 according to one or more embodiments is used by automatically obtaining a label by using the collected actual use dry information and thus the actual use dry information may be used for learning.

FIG. 4 is a block diagram illustrating a configuration of a dry device according to one or more embodiments.

The dry device 200 may include a dry part 210, a processor 220, memory 230, a display 240, a user interface 250, a communication interface 260, and a speaker 270. This dry device 200 may be a drier performing only a dry function and may be a washing machine performing a dry cycle and a washing cycle.

The dry part 210 may be a component for removing moisture. For example, the dry part 210 may be configured as a fan for generating wind and a heat generating device for change air flowing into through the fan to dry air (or hot air). Otherwise, the dry part 210 may be implemented in a form in which high speed rotation is possible. In this case, the dry part 210 may include a space into which a dry matter is inserted.

Hereinafter, for convenience of the description, the dry part 210 is described as drying a dry matter with hot air, but it is not limited thereto and if the dry part 210 uses wind or has a form of rotating in a high speed, it may be implemented in a form excluding part related to a temperature of the description below.

The memory 230 may refer to as hardware storing information such as data in an electric or magnetic form in order that the processor 220 or the like may access thereto. For the above, the memory 230 may be implemented as at least one hardware of non-volatile memory, volatile memory, flash memory, a hard disk drive (HDD) or a solid state drive (SDD), RAM, or ROM.

The memory 230 may store at least one instruction or module required for an operation of the dry device 200 or the processor 220. Here, the instruction may be written in a machine language, which is a computer-understandable language as a code unit instructing an operation of the dry device 200 or the processor 220. The module may be a series of instruction set of performing specific work in a work unit.

The memory 230 may store data which is information in a bit or bite unit indicating a character, a number, an image, or the like. For example, the memory 230 may store information about the dry matter in the memory 230. Also, the memory 230 may store a dry command type identifying module, a dry operation module, or the like. Here, each module may be implemented in a rule base model or in a learning model (or a neural network model).

The memory 230 may be accessed by the processor 220, wherein the processor 220 may perform reading/recording/correcting/deleting/renewing, or the like with respect to instructions, modules or data.

The memory 230 may store rule information for determining closing of the dry cycle or a learning model for determining closing of the dry cycle. Also, the memory 230 may store the learning model for identifying a material of the inserted dry matter.

Further, the memory 230 may store data collected from the sensor such as the touch pulse and information corresponding to the current dry cycle.

The display 240 may be implemented as a display having various forms such as a liquid crystal display (LCD), an organic light emitting diode (OLED) display, and a plasma display panel (PDP). The display 240 may include a driving circuit, a back light unit, or the like which may be implemented in a form such as an a-si TFT, a low temperature poly silicon (LTPS) TFT, or an organic TFT (OTFT). The display 240 may be implemented as a touch screen coupled to a touch sensor, a flexible display, a 3D display, or the like.

The user interface 250 may be implemented as a button, a touch pad, a mouse, a keyboard, or the like or may be implemented as a touch screen which may also perform together the aforementioned display function and the operation input function. Here, the button may be various types of buttons such as a mechanical button, a touch pad, or a wheel formed at any area such as a front part, a side part, a rear part, or the like of an appearance of a body of the dry device 200. A user may input a dry command through the user interface 250. Also, the user may input a material, a course to be performed among a plurality of courses, or the like through the user interface 250.

The communication interface 260 is a component performing a communication with various types of external devices according to various types of communication methods. For example, the dry device 200 may receive a user command for controlling the dry device 200 from the external device through the communication interface 260. Also, the dry device 200 may notify the user of information of a processing status (e.g. a processing time, a processing rate, a remaining time, closing of the dry cycle, etc.) of the dry cycle through the communication interface 260.

The communication interface 260 may include a Wi-Fi module, a Bluetooth module, an infrared communication module, a wireless communication module, etc. Here, each communication module may be implemented in a form of at least one hardware chip.

The Wi-Fi module and the Bluetooth module performs a communication in a Wi-Fi method and a Bluetooth method, respectively. In case of using the Wi-Fi module or the Bluetooth module, the module may receive and transmit various connection information such as SSID and a session key in advance, connect a communication by using the connection information, and then receive and transmit various information. The infrared communication module may perform a communication based on an infrared data association (IrDA) technology which transmits data wirelessly in a short distance by using infrared light between visible light and a millimeter wave.

The wireless communication module may include at least one communication chip performing a communication according to various wireless communication standards such as ZigBee, a 3rd generation (3G), a 3rd generation partnership project (3GPP), long term evolution (LTE), LTE Advanced (LTE-A), a 4th generation (4G), and a 5th generation (5G).

Alternatively, the communication interface 260 may include a wired communication interface such as a HDMI, DP, Thunderbolt, the USB, RGB, D-SUB, a DVI, or the like.

Besides, the communication interface 260 may include at least one of a local area network (LAN) module, an Ethernet module, or a wired communication module performing a communication by using a pair cable, a coaxial cable, a fiber optic cable, or the like.

The communication interface 260 may transmit actual use dry information collected in a dry cycle process to an external device (e.g. the electronic apparatus 100). Further, the communication interface 260 may receive the learning model determining a dry status or rule information determining a dry status from the electronic apparatus 100.

The speaker 270 is a component outputting not only various audio data processed in the processor 220 but also various alarms, voice messages, or the like. The processor 220 may output a sound indicating an operation status of the dry device 200, a sound indicating that an operation status is changed, a request sound for reconfirming a dry level, or the like through the speaker 270.

The processor 220 controls operations of the dry device 200 overall. Specifically, the processor 220 may be connected to each component of the dry device 200 to control operations of the dry device 200 overall. For example, the processor 220 may be connected to a component such as the dry part 210, the memory 230, the display 240, the communication interface 260, or the like to control operations of the dry device 200.

This processor 220 may be implemented as one or a plurality of processors. Here, the one or the plurality of processors may be a general purpose processor such as the CPU, an AP, a digital signal processor (DSP), a graphic dedicated processor such as a GPU or a vision processing unit (VPU), or an AI dedicated processor such as a NPU.

The one or the plurality of processors control to process input data according to a predefined operation rule or an AI model stored in the memory. Otherwise, if the one or the plurality of processors are the AI dedicated processor, the AI dedicated processor may be designed as a hardware structure specific to processing of a specific AI model. The predefined operation rule or the AI model is constructed by learning.

If a dry command is received, the processor 220 may control the dry part 210 to perform a dry operation based on the dry command. Here, the processor 220 may receive an input about dry material information or a type of the dry cycle through the user interface 250 and control the dry part 210 to perform a dry operation corresponding to the input dry material information and the type of the dry cycle. For example, the processor 220 may control a temperature of hot air to be used by the dry part 210 according to the type of the material and may determine a dry time or a reference value of closing of the dry cycle according to a material or a type of the dry cycle.

Further, the processor 220 may determine a dry status based on information inputted from the sensor. For example, the sensor may be a touch pulse, wherein the processor 220 may determine if the dry cycle is converted to a closing cycle, the dry cycle is closed, or the like in a criterion of whether a value of the touch pulse is a preset value or less. Here, the processor 220 may perform the above determination based on the learning model or rule information provided from the electronic apparatus 100.

Also, the processor 220 may directly use the touch pulse value and may calculate an indicator of a degree of dryness based on the touch pulse value and perform the above determination based on the calculated indicator of the degree of dryness.

If the dry cycle is closed, the processor 220 may generate information used for the relevant dry cycle and actual use dry information including time series data measured from the sensor and control the communication interface 260 to transmit the generated actual use dry information to the electronic apparatus 100. Upon implementing, the entire data about the degree of dryness measured in the entire section of the dry cycle may be transmitted to the electronic apparatus 100 and only data about the degree of dryness corresponding to a preset section (e.g. data corresponding to 10 minutes from a closing time point) may be transmitted thereto.

Also, if the processor 220 receive an input about a command of an additional dry cycle from the user after closing of the dry cycle, it may control the dry part 210 to perform additional drying. Further, the processor 220 may add information that the additional drying was performed to the existing actual use dry information.

Further, the processor 220 may receive the rule information or the learning model from the electronic apparatus 100 and store the received rule information or learning model in the memory 230. The operation as above may be received by the processor 220 periodically or upon occurrence of an event through a request for new rule information and a new learning model to the electronic apparatus 100.

In illustrating and describing FIG. 4, it is shown that many components are included in the dry device but upon implementing, part of the aforementioned components (e.g. the speaker) or the like may omitted and other components may be further included besides the aforementioned components.

For example, the dry device 200 may include a space for accommodating a dry matter. For example, the dry device 200 may include a space for accommodating the dry matter in a form of a dry basket or a dry drum.

However, the one or more embodiments is not limited thereto and the dry device 200 and the space for accommodating the dry matter may be implemented in a divided form. In this case, there is an additional device including a space for accommodating the dry matter, wherein the dry device 200 is disposed adjacent to a separate device and may perform a dry operation by supplying hot air to the space where the dry matter is accommodated.

As above, if the additional dry command is inputted, the dry device 200 performs an additional dry operation based on the previous dry operation method and thus efficient drying is possible while damages of the dry matter are prevented.

FIG. 5 is a view illustrating an example of data about a degree of dryness according to one or more embodiments.

With reference to FIG. 5, a sensor value outputted from a touch pulse value of the dry device 200 is illustrated in a time series.

Specifically, the touch pulse used in the one or more embodiments indicates a touch value (e.g. the number of electric conduction between two terminals) sensed by the touch pulse in (for example) a preset time unit.

If the moisture laundry is first loaded into the dry device 200, two terminals of the touch pulse is frequently conducted by the relevant laundry and as drying proceeds, the number of conduction (or a touch value) in the touch pulse is gradually reduced.

Specifically, if laundry having high moisture commonly touches two terminals of the touch pulse, the two terminals are conducted but laundry having low moisture (i.e. dried laundry) does not make the two terminals be conducted even if it commonly touches the two terminals of the touch pulse. Therefore, regardless of a proceeding situation of the dry cycle, even though the number of touches of laundry with two terminals of the touch pulse is identically maintained, an amount of moisture of the touching laundry is varied according to proceeding of the washing cycle and thus the sensor value of the touch pulse is gradually lowered.

As above, the dry device 200 may indirectly determine a dry status of the dry matter by using this touch pulse value.

However, if laundry having low moisture is disposed at an advantageous position for contacting the touch pulse and laundry having high moisture is disposed at a difficult position for contacting the touch pulse during the dry cycle, there is a case that partial laundry is in a less dried status even though the touch pulse outputs a low value.

Further, the aforementioned situation may be different according to a material of a dry object or a weight of the dry object and in this regard, it is difficult to simply determine closing of the dry cycle only based on a value of the touch pulse.

Also, conventionally, in order to prepare for the aforementioned situation, if the touch pulse has a certain low value, the dry cycle is converted to a closing stage, drying is further performed for a certain time or more, and then the dry cycle is closed, wherein an unnecessary dry time and wasted energy occur in this process.

Accordingly, there is a need to more accurately determine a dry status of the dry object. Therefore, in the one or more embodiments, the learning model is trained by using information collected from various actual use environments and a dry status of the dry object is determined by using the trained learning model.

In order to use the learning model, there should be various data and to train the learning model, a label value with respect to the relevant data (i.e. what a result of the relevant data is: normal dried, less dried, or over-dried) should be known.

As above, learning data and a label value with respect to the relevant data are needed for training of the learning model but it is difficult to give a label with respect to data of a use environment of the user rather than an experimental environment.

That is, even though the user obtains data used for a specific dry cycle from the drier in use, it is difficult to use data of the use environment of the user because it is not known what the result of the relevant dry cycle is: normal dried, over-dried, or less dried.

In the one or more embodiments, a label is given by using actual use dry data collected without a label and the learning model is trained by using the given label. Hereinafter, a labeling operation according to the one or more embodiments is described with reference to FIG. 6

FIG. 6 is a view illustrating a labeling method with respect to a dry result according to one or more embodiments.

With reference to FIG. 6, a dryness indicator value is calculated by using a time series data of a degree of dryness 610 in advance.

For example, an indicator of a degree of dryness 620 may be calculated by using one or more sensor values within a preset section in the data about the degree of dryness, or by using a value of a sum of the one or more sensor values within the preset section in the data about the degree of dryness. An indicator value of this indicator of the degree of dryness may be calculated in a different method according to an object of the dry matter. That is, a dry characteristic of each of a wool material or a material such as blue jeans may be different from each other and the indicator value may be calculated by using a different calculation method according to a material. Upon implementing, the dryness indicator value may be calculated by using the same calculation method, giving a different weight value according to a material, and applying the different weight value according to the material to a calculation value.

Further, a dry status (i.e. a label) 630 may be determined by using the calculated dryness indicator value. Specifically, the dry status of the laundry may be divided into a less dried status, a normal dry status, an over-dried status, wherein the three dry statuses have continuous arrangements. That is, the indicator value and the aforementioned three dry statuses have some correlation.

To divide this dry status, there is a need to determine a reference value of each aforementioned status (e.g. a reference value of dryness for separating the less dried status from the normally dried status, etc.).

To determine this reference value, the quartile may be used. That is, when the reference value of dryness of each of collected data is based on a normal distribution, a reference value corresponding to the top 25% and a reference value corresponding to the bottom 25% may be used for a first reference value for separating the less dried status from the normally dried status and a second reference value for separating the normally dried status from the over-dried status, respectively.

Otherwise, clustering may be performed by using the reference value of dryness of each of the collected data and a value for separating each clustering may be also used as the first reference value or the second reference value.

It is illustrated as above that labeling is performed by using only the calculated reference value of dryness but upon implementing, labeling may be also performed by utilizing other information besides the reference value of dryness. For example, there may be a case that the user inputs a dry cycle command and inputs an additional dry command directly after closing of the relevant dry cycle command. In the case as above, it is assumed that the user inputs additional drying because the dry status is in a less dried status, wherein if the case is that the additional dry command is input within a preset time without changing an amount of the dry matter after closing of the dry cycle, it is possible that the label value with respect to the previous dry cycle is determined as the less dried status.

It is described that the label is given by using data collected from the dry device as above. However, it may be applied to various cycles of the washing machine besides the dry cycle and the aforementioned operations may be applied to the actual use data of other devices besides the dry device. That is, if there is time series data or the like which may collect data collected without a label and may give a label by using the collected data, the content of this application may be applied.

For example, related to a rinsing cycle of the washing machine, it is also possible to collect the time series data (or data according to the number of rinsing) from a sensor sensing a detergent concentration (or turbidity) diluted in water or the like and label it with whether rinsing normally operates by using the collected data. Alternatively, related to the washing cycle of the washing machine, it is also possible to label it with whether the washing cycle normally operates (i.e. whether the washing time is proper) by using the time series data collected from the sensor sensing a concentration (or turbidity) diluted in water.

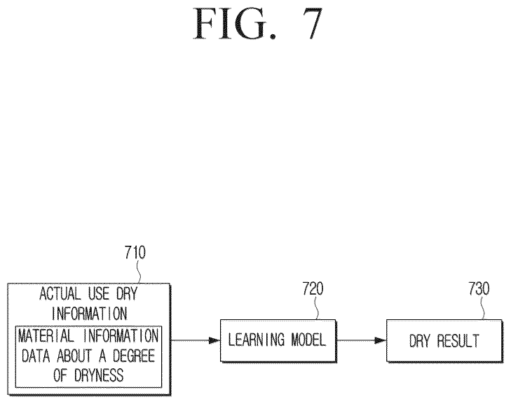

FIG. 7 is a view illustrating a learning model according to one or more embodiments.

As shown in FIG. 7, the processor 220 may confirm the dry status by using the learning model 720. Specifically, the processor 220 may input actual use dry information 710 into a learning model 729 as input data and may obtain the dry status 730 as output data.

Here, the actual use dry information 710 may include time series data of the degree of dryness, course information, material information, etc. Further, the dry status as the output information may be status information such as over-dried, normally dried, less dried statuses and upon implementing, a value corresponding to each status (e.g. over-dried=1, normally dried=0, or less dried=−1) may be output. Upon implementing, the dry status may be subdivided into four or more steps rather than three steps or it is also possible to divide and use it into only two steps such as less dried and normally dried statuses.

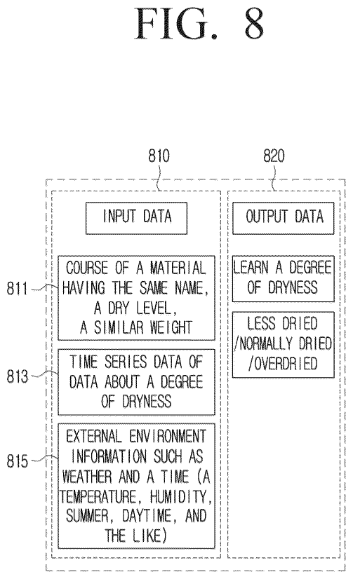

FIG. 8 is a view illustrating a use example of a learning model according to one or more embodiments.

With reference to FIG. 8, the learning model may receive an input 810 of three types of data as shown and may output a value 820 corresponding to the dry status (i.e. three statuses such as less dried, normally dried, and over-dried statuses) corresponding to the input information.

For example, the input data may be information recognizable in the dry device 200 like the dry cycle such as information about a material type (or a course) and information about a weight (811), information measured through the sensor such as time series data (813), and external environment information (815). The external environment information may be information directly measured from the dry device 200, information using weather information stored in an external server though position information of the dry device 200, or the like.

As above, the learning model shown in FIG. 8 receives an input of a value of a material and a weight of the dry matter and performs learning and inference by using the learning model corresponding to the input material and weight. Accordingly, different dry results may be output according to each material and weight even with respect to the same time series data.

As above, in the one or more embodiments, classifying a material of the dry matter and using its value are illustrated and described but upon implementing, it may be difficult to classify the material.

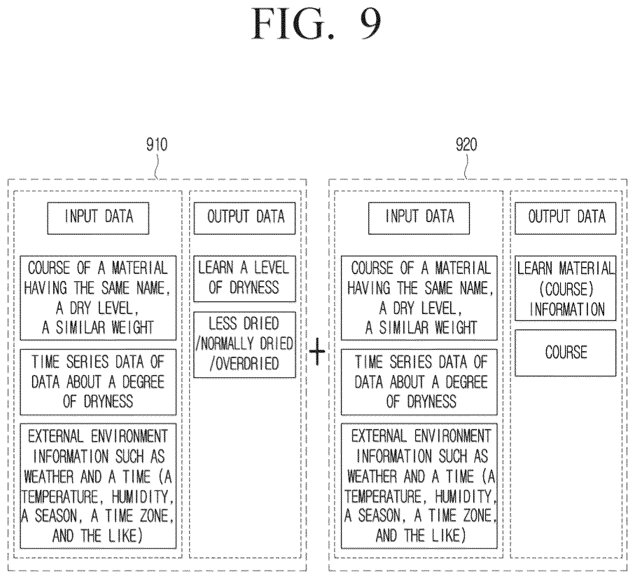

For example, there are many cases that the user dries various types of laundry in a standard dry course and even though the user classifies and dries the laundry, the user may input a dry command only in the standard dry course without selecting a course corresponding to the material. That is, the dry information may not include information about a dry material. Hereinafter, a learning operation and an inference operation of this case are described with reference to FIG. 9.

FIG. 9 is a view illustrating a use example of a learning model according to one or more embodiments.

With reference to FIG. 9, two learning models are used.

A first learning model 910 is a learning model predicting a dry status and a second learning model 920 is a learning model predicting a material of a dry matter.

The first learning model 910 and the second learning model 920 may be trained by using the collected learning data. Further, two models may operate in parallel or after the second learning model is applied, the first learning model may be also implemented in a form of operating by using its result.

For example, the second learning model performs learning by using preferentially collected data, a material is assumed with respect to data to be used for the first learning model through the trained second learning model and then, the first learning model may be trained by the assumed material information.

Also, even in the assumption process, the material may be assumed by preferentially using the second learning model and dry information may be assumed by inputting the assumed material and the actual use dry information into the first learning model.

In contrast, in the assumption process, the actual use dry information may be input into each learning model in parallel and the dry information may be finally assumed by adding up values outputted from each learning model.

In FIGS. 8 and 9, it is illustrated and described that the learning model is trained in consideration of information about a dry environment, i.e., a date, a time, external environment information, and the like or when using the learning model, the relevant information is also used as an input value. However, the using the aforementioned information may be omitted upon implementing.

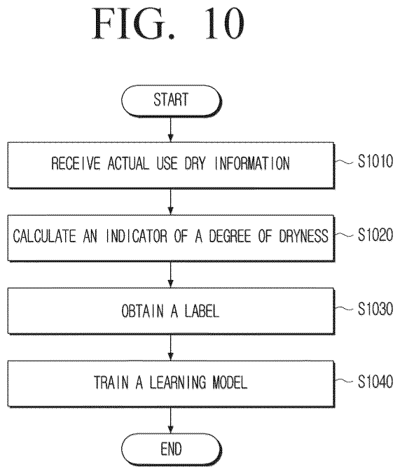

FIG. 10 is a view illustrating a control operation of an electronic apparatus according to one or more embodiments.

With reference to FIG. 10, the electronic apparatus receives actual use dry information including data about a degree of dryness (S1010).

Then, an indicator of the degree of dryness is calculated by using the data about the degree of dryness included in the received actual use dry information (S1020). Specifically, the indicator of the degree of dryness may be calculated by using one or more sensor values within a preset section in the data about the degree of dryness, or by using a value of a sum of the one or more sensor values within the preset section in the data about the degree of dryness. Here, the indicator of the degree of dryness may be calculated by using a weight value corresponding to material information included in the received actual use dry information and the data about the degree of dryness.

Then, a label about the actual use dry information is obtained by using the calculated indicator of the degree of dryness (S1030). Specifically, a value section of the indicator of the degree of dryness is divided into a plurality of sections and a label about the data about the degree of dryness may be obtained by using an indicator value separating each section and the calculated indicator of the degree of dryness.

Then, the learning model determining a dry status is trained by using the obtained label and the actual use dry information (S1040). Specifically, the learning model may be trained by using a dry weight, a dry material, the data about the degree of dryness, and the obtained label. If the actual use dry information does not include information of the dry material, the dry material may be preceedingly assumed by using the learning model predicting the dry material by using the received actual use dry information and the assumed result may be used.

As above, if the learning model is trained, the trained learning model is transmitted to the dry device or rule information related to closing of the dry cycle is generated by using the trained learning model and then the generated rule information may be transmitted to the dry device.

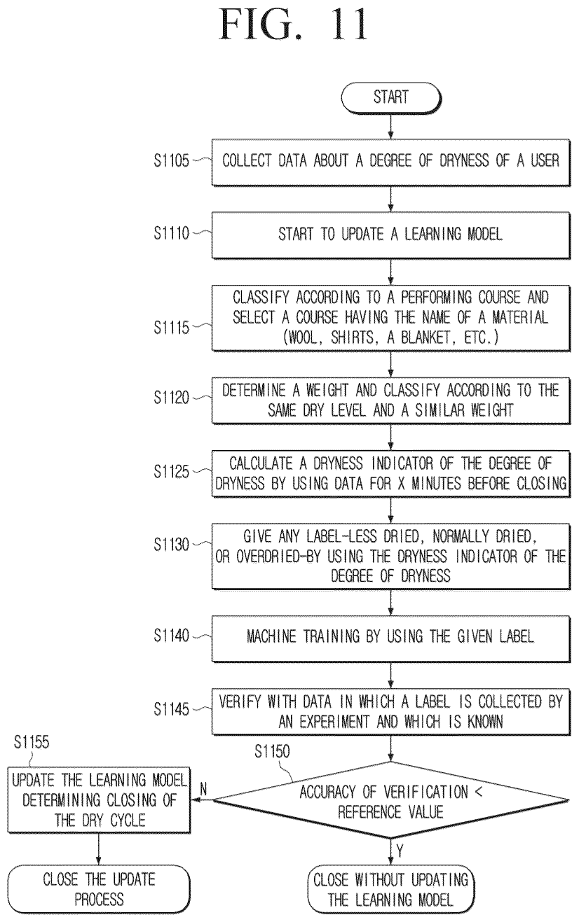

FIG. 11 is a view illustrating a learning operation of a learning model according to one or more embodiments.

With reference to FIG. 11, data about the degree of dryness of the user is collected (S1105). Specifically, it may include actual use dry information which includes information about the dry cycle from each of a plurality of dry devices and time series dry information collected in the relevant dry cycle process. Here, the information about the dry cycle may include information about the dry cycle selected by the user among a plurality of dry cycles supported by the dry device, weight information measured in the relevant dry device, material information selected by the user, and the like.

Then, it is determined whether the number (or an amount) of the collected data about the degree of dryness of the user becomes a preset level, i.e., an amount sufficient to train the learning model and if the data about the degree of dryness of the user is collected in the preset level or more, the learning operation may be performed (S1110).

Further, data to be applied to one learning model among the collected data about the degree of dryness may be selected. Specifically, to train the learning model by using only data having the same course and a similar weight, data about the degree of dryness may be classified in a criterion of a performing course, a material, a weight, or the like (S1115, S1120). Upon implementing, if only one learning model is trained, the aforementioned classification may not be performed.

Then, a dryness indicator is calculated (S1125). Specifically, the dryness indicator of the degree of dryness may be calculated by using time series dryness data within the actual use dry information.

Then, labeling with respect to the relevant actual use dry information may be performed by using the calculated dryness indicator of the degree of dryness (S1130). Here, labeling may be classified as three types such as less dried, normally dried, and over-dried statuses. Upon implementing, the aforementioned labeling is one example and labeling may be performed in a specific numeral value.

Then, the learning model may be trained by using the obtained label and the actual use dry information (S1140).

Thereafter, verification with respect to the trained learning model may be performed (S1145). Specifically, the relevant learning model may be verified by using data known through an experimental result of a laboratory. If verification is completed (S1150-Y), a performance is made such that the relevant learning model is distributed to each dry device (S1155).

On the contrary, if the verification is not passed (S1150-Y), an update of the learning model may be closed.

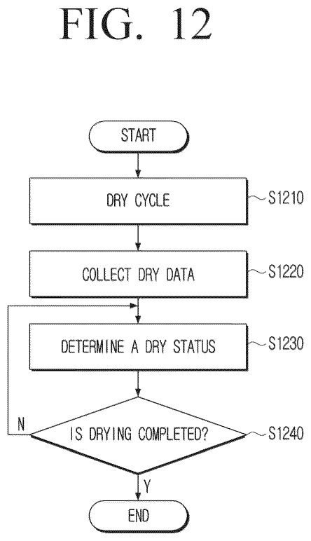

FIG. 12 is a view illustrating a control operation of a dry device according to one or more embodiments.

With reference to FIG. 12, a dry cycle may be performed according to a dry command (S1210). Here, data about the degree of dryness may be collected and stored by storing data received from the sensor in a time series during the dry cycle (S1220).

Then, a dry status may be determined by using the collected data about the degree of dryness and information of the dry cycle (S1230). Specifically, the dry status may be determined by inputting closing of the dry cycle, a material, and the collected data about the degree of dryness into the learning model received from the electronic apparatus. Otherwise, the dry status may be determined by using the rule information for determining whether to close the dry cycle and the aforementioned information.

As a result of determination, if the normally dried status is determined, the dry cycle may be closed or may enter into a stage of a closing cycle for performing the dry operation for a certain time and closing the dry cycle (S1240).

As a result of determination, if the less dried status rather than the normally dried status is determined, it is possible to continue the stage of the dry cycle (S1240-N).

As above, the dry device according to the one or more embodiments determines the dry status by using the learning model trained by using various actual use dry information and thus the dry operation may be closed with higher accuracy.

According to one or more embodiments of the one or more embodiments, various examples described above may be implemented as software including instructions stored in machine (e.g. a computer) readable storage media. The machine refers to a device which calls instructions stored in storage media and is operable according to the called instructions, wherein it may include a dry device (e.g. a dry device A) according to the one or more embodiments. If the instructions are executed by a processor, the processor may perform a function corresponding to the instructions directly or by using other components under control of the processor. The instructions may include a code generated or executed by a compiler or an interpreter. A machine readable storage medium may be provided in a form of a non-transitory storage medium. Here, ‘non-transitory’ merely means that the storage medium does not include a signal and are tangible, wherein it does not distinguish whether data is stored in the storage medium semi-permanently or temporarily.

Also, according to one or more embodiments of the disclosure, a method according to various examples described above may be provided to be included in a computer program product. The computer program product may be traded between a seller and a buyer as goods. The computer program product may be distributed on-line in a form of the machine readable storage media (e.g. compact disc read only memory (CD-ROM)) or via an application store (e.g. play store™). In the case of on-line distribution, at least part of the computer program product may be stored at least temporarily or may be generated temporarily in the storage media such as memory of a server of a manufacturer, a server of an application store, or a relay server.

Also, according to one or more embodiments of the disclosure, various embodiments described as above may be implemented in a recording medium that may be read by a computer or a device similar thereto by using software, hardware, or a combination thereof. In some cases, embodiments described in the specification may be implemented as a processor itself. According to software implementation, embodiments such as procedures and functions described in the specification may be implemented as separate software modules. Each of software modules may perform one or more functions and operations described in the specification.

Computer instructions for performing the processing operation of the machine according to the various embodiments above may be stored in a non-transitory computer readable medium. Computer instructions stored in this non-transitory computer readable medium that, when executed by a processor of a specific device, causes the specific device to perform a processing operation of the device according to the various embodiments. The non- transitory computer readable medium means not only a medium storing data for a short time such as a resistor, a cache, memory, or the like but also a machine readable medium. A specific example of the non-transitory computer readable medium may be a CD, a DVD, a hard disk, a Blu-ray disk, a USB, a memory card, ROM, and the like.

Also, each of components (e.g. a module or a program) according to the various embodiments above may be configured as a single item or a plurality of items, wherein partial subcomponents of the aforementioned relevant subcomponents may be omitted or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, or at least part of the operations may be executed in different orders or be omitted, or another operation may be added.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. An electronic apparatus comprising:
a communication device;
memory storing at least one instruction and storing a learning model determining a dry status; and
at least one processor configured to execute the at least one instruction,
wherein the one or more instructions, when executed by the at least one processor, cause the electronic apparatus to:
based on receiving through the communication device actual use dry information including data about a degree of dryness, obtain an indicator of a degree of dryness based on the data about the degree of dryness included in the actual use dry information;
obtain a label of the data about the degree of dryness based on the indicator of the degree of dryness; and
train the learning model by using the label and the actual use dry information.

2. The electronic apparatus of claim 1, wherein the one or more instructions, when executed by the at least one processor, cause the electronic apparatus to:
obtain the indicator of the degree of dryness based on one or more sensor values within a preset section in the data about the degree of dryness or a value of a sum of the one or more sensor values within the preset section in the data about the degree of dryness.

3. The electronic apparatus of claim 1, wherein the one or more instructions, when executed by the at least one processor, cause the electronic apparatus to:
obtain the indicator of the degree of dryness is based on a weight value corresponding to material information included in the actual use dry information and the data about the degree of dryness.

4. The electronic apparatus of claim 1, wherein the one or more instructions, when executed by the at least one processor, cause the electronic apparatus to:
divide a value section of the indicator of the degree of dryness into a plurality of sections and obtain the label about the data about the degree of dryness based on an indicator value separating each section and the indicator of the degree of dryness.

5. The electronic apparatus of claim 4, wherein the one or more instructions, when executed by the at least one processor, cause the electronic apparatus to:
divide a plurality of indicator values of the degree of dryness into a second plurality of sections by using a quartile method or a clustering method, the plurality of indicator values of the degree of dryness being obtained based on a plurality of actual use dry information.

6. The electronic apparatus of claim 1, wherein the one or more instructions, when executed by the at least one processor, cause the electronic apparatus:
train the learning model based on a dry weight, a dry material, the data about the degree of dryness, and the label.

7. The electronic apparatus of claim 6, wherein the one or more instructions, when executed by the at least one processor, cause the electronic apparatus to:
train the learning model to predict the dry material based on the actual use dry information.

8. The electronic apparatus of claim 7, the memory is configured to store the learning model predicting the dry material, and
wherein the one or more instructions, when executed by the at least one processor, cause the electronic apparatus to:
train the learning model to predict the dry material by inputting the actual use dry information into the learning model and determining the dry status based on the predicted dry material and the actual use dry information.

9. The electronic apparatus of claim 1, wherein the one or more instructions, when executed by the at least one processor, cause the electronic apparatus to:
control the communication device to transmit the trained learning model to a dry device.

10. The electronic apparatus of claim 1, wherein the one or more instructions, when executed by the at least one processor, cause the electronic apparatus to:
control the communication device to generate rule information related to closing of a dry cycle based on the trained learning model; and
transmit the rule information to a dry device.

11. A control method of an electronic apparatus, the control method comprising:
receiving actual use dry information comprising data about a degree of dryness;
obtaining an indicator of the degree of dryness based on the data about the degree of dryness included in the actual use dry information;
obtaining a label about the actual use dry information based on the indicator of the degree of dryness; and
training a learning model for determining a dry status by using the label and the actual use dry information.

12. The control method of claim 11, wherein the obtaining the indicator of the degree of dryness comprises obtaining the indicator of the degree of dryness based on one or more sensor values within a preset section in the data about the degree of dryness or a value of a sum of the one or more sensor values within the preset section in the data about the degree of dryness.

13. The control method of claim 11, wherein the obtaining the indicator of the degree of dryness comprises obtaining the indicator of the degree of dryness based on a weight value corresponding to material information included in the actual use dry information and the data about the degree of dryness.

14. The control method of claim 11, wherein the obtaining the label comprises dividing a value section of the indicator of the degree of dryness into a plurality of sections and obtaining the label about the data about the degree of dryness based on an indicator value separating each section and the indicator of the degree of dryness.

15. A non-transitory computer readable recording medium storing computer program instructions that are executed by a processor of an electronic apparatus to perform a control method of the electronic apparatus, wherein the control method comprises:
receiving actual use dry information including data about a degree of dryness;
obtaining an indicator of the degree of dryness based on the data about the degree of dryness included in the actual use dry information;
obtaining a label about the actual use dry information based on the indicator of the degree of dryness; and
training a learning model for determining a dry status by using the label and the actual use dry information.
